(19) United States
(12) Patent Application Publication
(10) Pub. No.: US 2009/0030741 A1
(43) Pub. Date: Jan. 29, 2009

(54) CONSUMER BOOKING ENGINE AND METHOD

(76) Inventor: Colin Veitch, Pinecrest, FL (US)

Correspondence Address: Sheppard Mullin Richter & Hampton LLP, 1300 I Street NW, 11 th Floor East, Washington, DC, 20005, US

(21) Appl. No.: 11/781,438

(22) Filed: Jul. 23, 2007

(51) Int. Cl. G06Q 10/00; G06Q 30/00

(52) U.S. Cl. 705/5; 705/26

(57) ABSTRACT

The present invention provides methods, systems, and articles of manufacture that enable a seller to better maximize its revenue and, more particularly, to methods, systems, and articles of manufacture that enable a seller of a good or service that has multiple categories, classes, and/or price levels to upsell a higher category, class, and/or price level of such a good or service to a customer that has already purchased such a good or service.

### FIELD OF THE INVENTION

The invention broadly relates to methods, systems, and articles of manufacture that enable a seller to better maximize its revenue and, more particularly, to methods, systems, and articles of manufacture that enable a seller of goods or services to upsell a higher category, class, and/or price level of such goods or services, or related goods or services, to a customer that has already purchased such goods or services.

### BACKGROUND OF THE INVENTION

As their operations expand, sellers experience challenges in effective pricing and inventory management. This problem may affect sellers of any good and service, including hotel operators, airlines, concert promoters, playhouses, ticket vendors, and cruise operators. Thus far, most efforts to solve the problem have occurred in the travel industry. For example, to deal with these issues, cruise operators, airlines, and other travel-related sellers have developed sophisticated revenue management systems (RMSs) to optimize their revenue. For example, when a cruise berth is first added to a cruise operator's schedule, the cruise operator's revenue management system attempts to maximize revenue for the berth by establishing a plurality of fare classes and then allocating the number of cabins and price assigned to each fare class. The revenue management system will thereafter continue to monitor the actual demand within each fare class relative to forecasted demand, dynamically reevaluating the inventory allocation and pricing of each fare class for a given berth. In this manner, the cruise operators attempt to obtain maximum revenue from each sailing of a given ship.

While conventional RMSs employ sophisticated tools to anticipate future demand, forecasting errors and unexpected external events, such as a price war or extreme weather conditions, invariably lead to unanticipated excess capacity or supply. Such errors and events also lead to inefficient pricing of goods or services, including the various classes of travel services (e.g., classes or categories of cruise ship staterooms) and, consequently, an allocation of the supply or capacity in a manner that does not maximize the profit for the seller. Thus, for example, in an attempt to reduce such excess capacity, cruise operators periodically reevaluate the inventory allocation and pricing of each fare class for a given berth. A cruise operator cannot simply discount the published fares for such unsold cabins, however, without compromising its own underlying fare structure (i.e., without also reducing its prices for higher-fare travelers). Thus, there is currently no effective way for cruise operators to dispose of such excess capacity or re-allocate existing capacity to maximize profits.

Currently, cruise operators and other sellers of goods and services attempt to sell excess capacity or supply utilizing consolidators, who traditionally sell goods or services at a discount. In addition, companies like priceline.com® now offer systems where customers can make offers for travel-related goods and services at customer-defined prices. Both options fail to adequately solve the problems. For example, since the terms of the relationship between the sellers of travel-related goods and services and the consolidators are generally not good or service specific and are typically defined months in advance, the sale of goods or services through a consolidator does not provide a sufficiently dynamic mechanism for sellers to sell such excess supply or capacity when the actual demand fails to meet the forecasted demand. Even assuming that the sellers could release the goods or services for sale through the consolidators at the last minute, there is currently no effective way for the consolidators to announce the availability and price of such goods and services to customers. Moreover, consumers may be uncomfortable or unfamiliar with using a system such as priceline.com® and such a system cannot target consumers who have already purchased a particular good or service.

Sellers recognize that there is a latent demand associated with consumers who are willing to purchase various goods and services at a discount. In particular, cruise operators and other sellers of travel-related services recognize that there is a large source of latent demand associated with leisure travelers who are willing to travel at a favorable price and more specifically, a latent demand associated with travelers who may be willing to purchase a higher class of stateroom or the like at a favorable price. Such applies to both customers that have already booked a trip and may want to upgrade to a higher class of stateroom or the like, just as much as it applies to customers that have not yet booked a trip and are on the lookout for favorable prices. However, there is currently no effective way for a cruise operator or other seller of travel-related services to make an offer to an existing customer for leisure travel for an upgraded class or category of room or service at a favorable price below the operator's published fare for a given class or category.

As is apparent from the above deficiencies with conventional systems for selling goods and services, such as cruise tickets, a need exists for a system that permits a seller to sell excess supply or capacity when actual demand fails to meet forecasted demand. Moreover, a need exists for a system or method that permits a cruise operator or other seller of travel or other goods or services to maximize profits made from any given cruise berth (or the like). A further need exists for a buyer-driven system that permits a cruise operator to sell tickets to leisure travelers at a favorable price, typically below the cruise operator's published fare. Yet another need exists for a system that permits sellers to stimulate sales of excess inventory of any particular good or service, without compromising the seller's published price structure. Another need exists for a system that permits sellers to capture and process consumer demand for each selling price of a given item, such as a given fare class on each cruise berth.

### SUMMARY OF THE INVENTION

The present invention provides methods, systems, and articles of manufacture that may satisfy the above needs. The present invention provides methods, systems, and articles of manufacture that provide sellers of goods and services and in particular travel-related goods and services a way to efficiently manage their inventories and maximize profits. More specifically, the present invention includes methods, systems, and articles of manufacture that enable a seller of a good or service that has multiple categories, classes, and/or price levels to upsell a higher category, class, and/or price level of such a good or service to a customer that has already purchased such a good or service.

In some embodiments, the present invention is a method including the steps of presenting the customer with at least one upgrade with a plurality of prices for the good or service, receiving a bid from the customer, where the bid is for the at least one upgrade for one of the plurality of prices, and deciding whether to accept the bid from the customer. In some embodiments, the deciding step includes querying a database comprising bids of a plurality of customers, identifying the bids for each upgrade that selected the highest of the plurality of prices, and determining the availability of each the upgrade. In some embodiments, the database may be stored in a computer reservation management system. In some embodiments, the method includes offering the upgrade to the customer at the price of the bid. In some embodiments the method includes processing the customer's acceptance or refusal of the offer for the upgrade. In some embodiments the deciding step takes place at a time concurrently to the date of delivery of the good or service. In some embodiments the method includes receiving a payment identifier specifying a credit card account for use in providing payment for the upgrade. In some embodiments the good or service may be a cruise reservation, flight reservation, train reservation, car rental reservation, or a hotel reservation. In some embodiments the good or service may be a cruise reservation and the upgrade may be a stateroom class or category. In some embodiments the method also includes presenting the customer with an offer to purchase a second good or service. In some embodiments the second good or service is related to the at least one upgrade.

In some embodiments, the present invention is a method including the steps of receiving a purchase offer for a good or service, presenting the customer with at least one upgrade with a plurality of prices for the good or service, receiving a bid from the customer, where the bid is for the at least one upgrade for one of the plurality of prices, and deciding whether to accept the bid from the customer. In some embodiments, the deciding step includes querying a database comprising bids of a plurality of customers, identifying the bids for each upgrade that selected the highest of the plurality of prices, and determining the availability of each the upgrade. In some embodiments, the database may be stored in a computer reservation management system. In some embodiments, the method includes offering the upgrade to the customer at the price of the bid. In some embodiments the method includes processing the customer's acceptance or refusal of the offer for the upgrade. In some embodiments the deciding step takes place at a time concurrently to the date of delivery of the good or service. In some embodiments the method includes receiving a payment identifier specifying a credit card account for use in providing payment for the upgrade. In some embodiments the good or service may be a cruise reservation, flight reservation, train reservation, car rental reservation, or a hotel reservation. In some embodiments the good or service may be a cruise reservation and the upgrade may be a stateroom class or category. In some embodiments the method may also include presenting the customer with an offer to purchase a second good or service. In some embodiments the second good or service is related to the at least one upgrade.

In other embodiments, the present invention may be a system including a memory device storing a program, and a processor in communication with the memory device, where the processor is operable with the program to: receive a purchase offer for a good or service from a customer, present the customer with at least one upgrade with a plurality of prices for the good or service, receive a bid from the customer, wherein the bid is for at least one upgrade for one of the plurality of prices, and decide whether to accept the bid from the customer. In some embodiments the processor may be further operable to query a database comprising bids of a plurality of customers, identify bids for each upgrade that selected the highest of the plurality of prices, and determine the availability of each upgrade. In some embodiments the processor may be further operable to offer the upgrade to the customer at the price of the bid. In some embodiments the processor may be further operable to process the customer's acceptance or refusal of the offer for the upgrade. In some embodiments the processor may be further operable to receive a payment identifier specifying a credit card account for use in providing payment for the upgrade. In some embodiments the good or service may be a cruise reservation, flight reservation, train reservation, car rental reservation, or a hotel reservation. In some embodiments the good or service may be a cruise reservation and the upgrade may be a stateroom class or category. In some embodiments the processor may also be operable to present the customer with an offer to purchase a second good or service. In some embodiments the second good or service is related to the at least one upgrade.

In other embodiments the present invention may be an article of manufacture including a computer readable medium comprising instructions, the instructions comprising instructions for: receiving a purchase offer for a good or service from a customer, presenting the customer with at least one upgrade with a plurality of prices for the good or service, receiving a bid from the customer, wherein the bid is for at least one upgrade for one of the plurality of prices, and deciding whether to accept the bid from the customer. In some embodiments the instructions also include instructions for communicating the offer to the customer. In some embodiments, the instructions also include instructions for processing the acceptance or refusal of the offer for the upgrade. In some embodiments the instructions for deciding also include instructions for querying a database comprising bids of a plurality of customers, identifying the bids that selected the highest of the plurality of prices, and determining the availability of the upgrade. In some embodiments the instructions also include instructions for receiving a payment identifier specifying a credit card account for use in providing payment for the upgrade. In some embodiments the good or service may be a cruise reservation, flight reservation, train reservation, car rental reservation, or a hotel reservation. In some embodiments, the good or service may be a cruise reservation and the upgrade may be stateroom classes or categories. In some embodiments the instructions also include instructions for presenting the customer with an offer to purchase a second good or service. In some embodiments the second good or service is related to the at least one upgrade.

In other embodiments the present invention may be an article of manufacture including a device for storing instructions, the instructions including instructions for: receiving a purchase offer for a good or service from a customer, presenting the customer with at least one upgrade with a plurality of prices for the good or service, receiving a bid from the customer, wherein the bid may be for at least one upgrade for one of the plurality of prices, and deciding whether to accept the bid from the customer.

In some embodiments the present invention may be a system including a device for storing a program, a device for communicating with the device for storing a program, the device for communicating operable with the device for storing to receive a purchase offer for a good or service from a customer, present the customer with at least one upgrade with a plurality of prices for the good or service, receive a bid from the customer, wherein the bid is for the at least one upgrade for one of the plurality of prices, and decide whether to accept the bid from the customer. In some embodiments the device for communicating may be further operable with the device for storing to offer one or more of the upgrades to the customer at the price of the bid.

In some embodiments the present invention may be a system including a memory device storing a program, a processor in communication with the memory device where the processor is operable with the program to: present a plurality of customers with at least one upgrade with a plurality of prices for the good or service, receive a bid from one or more of the plurality of customers, wherein the bid is for the at least one upgrade for one of the plurality of prices, and decide whether to accept the bid from the customer.

In some embodiments the present invention may be a system including a memory device storing a program, a processor in communication with the memory device where the processor is operable with the program to: receive a purchase offer for a good or service from a plurality of customers, present each of the plurality of customers with at least one upgrade with a plurality of prices for the good or service, receive a bid from each of the plurality of customers, wherein the bid is for the at least one upgrade for one of the plurality of prices, and decide whether to accept the bid from the customer. In some embodiments the processor may also be operable to: query a database comprising the bids of the plurality of customers, identify the bids for each upgrade that selected the highest of the plurality of prices, and determine the availability of each the upgrade. In some embodiments the processor may also be operable to offer the upgrade to each of or a subset of the plurality of customers at the price of the bid. In some embodiments the processor may also be operable to process the acceptance or refusal of the offer for the upgrade by each of the plurality of customers. In some embodiments the processor may also be operable to receive a payment identifier specifying a credit card account for use in providing payment for the upgrade. In some embodiments the good or service may be a cruise reservation, flight reservation, train reservation, car rental reservation, or a hotel reservation. In some embodiments the good or service may be a cruise reservation and the upgrade may be a stateroom class or category. In some embodiments the processor may also be operable to again decide whether to offer one or more of the upgrades to each of or a subset of the plurality of consumers. In some embodiments the processor may also be operable to query a database comprising the bids of the plurality of customers, identify bids for each upgrade that selected the highest of the plurality of prices, and determine the availability of each upgrade.

In some embodiments the present invention may be an article of manufacture that includes a computer readable medium comprising instructions, the instructions including instructions for: presenting a plurality of customers with at least one upgrade with a plurality of prices for the goods or services, receiving a bid from at least one of the plurality of customers, wherein the bid is for the at least one upgrade for one of the plurality of prices and deciding whether to accept the bid from the customer.

In some embodiments the present invention may be an article of manufacture that includes a computer readable medium comprising instructions, the instructions including instructions for: receiving a purchase offer for a good or service from a plurality of customers, presenting each of the plurality of customers with at least one upgrade with a plurality of prices for the goods or services, receiving a bid from at least one of the plurality of customers, wherein the bid is for the at least one upgrade for one of the plurality of prices and deciding whether to accept the bid from the customer. In some embodiments the instructions also include instructions for communicating the offer to at least one of the plurality of customers. In some embodiments the instructions also include instructions for processing the acceptance or refusal of the offer for the upgrade. In some embodiments the instructions for deciding also include instructions for querying a database comprising bids from the plurality of customers, identifying the bids that selected the highest of the plurality of prices, and determining the availability of the upgrade. In some embodiments the instructions also include instructions for receiving a payment identifier specifying a credit card account for use in providing payment for the upgrade. In some embodiments the good or service may be a cruise reservation, flight reservation, train reservation, car rental reservation, or a hotel reservation. In some embodiments the good or service may be a cruise reservation, and the upgrade may be a stateroom class or category. In some embodiments the instructions also comprise again deciding whether to offer one or more of the upgrade to each of the plurality of consumers. In some embodiments the instructions for deciding include instructions for querying a database comprising bids from the plurality of customers, identifying the bids that selected the highest of the plurality of prices, and determining the availability of the upgrade.

In some embodiments, the present invention may be a method including receiving a purchase offer for a good or service from a first set of customers, presenting the first set of customers with at least one upgrade with a plurality of prices for the good or service, receiving a bid from one or more of the first set of customers, wherein the bid is for the at least one upgrade for one of the plurality of prices; deciding whether to accept the bid from one or more of the first set of customers; and presenting an opportunity to purchase a good or service to a second set of customers, wherein the good or service comprises a good or service available as a result of the acceptance of one of the bids from one or more of the first set of customers. In some embodiments the deciding step includes querying a database comprising bids of a plurality of the first set of customers, identifying the bids for each upgrade that selected the highest of the plurality of prices; and determining the availability of each the upgrade. In some embodiments the database is stored in a computer reservation system. In some embodiments the method may also include offering the upgrade to one or more of the first set of customers at the price of the bid. In some embodiments the method may also include processing acceptance or refusal of the offer for the upgrade by one or more of the first set of customers. In some embodiments the deciding step takes place at a time concurrently to the date of delivery of the good or service. In some embodiments the deciding step includes consideration of at least one non-price criterion. In some embodiments the method may also include receiving a payment identifier specifying a credit card account for use in providing payment for the upgrade. In some embodiments the good or service may be a cruise reservation, flight reservation, train reservation, car rental reservation, or a hotel reservation. In some embodiments the good or service is a cruise reservation and the upgrade is a stateroom class or category. In some embodiments the method may also include presenting the first set of customers with an offer to purchase a second good or service. In some embodiments the second good or service is related to the at least one upgrade. In some embodiments the first set of customers is one customer. In some embodiments the first set of customers is a plurality of customers. In some embodiments the second set of customers is one customer. In some embodiments the second set of customers is a plurality of customers. In some embodiments the first set of customers is mutually exclusive of the second set of customers. In some embodiments the first set of customers has one or more customers in common with the second set of customers.

In some embodiments, the present invention may be a system including a memory device storing a program; a processor in communication with the memory device; the processor operable with the program to: receive a purchase offer for a good or service from a customer; present the customer with at least one upgrade with a plurality of prices for the good or service; receive a bid from the customer, wherein the bid is for the at least one upgrade for one of the plurality of prices; and decide whether to accept the bid from the customer. In some embodiments the processor is also operable to: query a database comprising bids of a plurality of customers, identify the bids for each upgrade that selected the highest of the plurality of prices, and determine the availability of each the upgrade. In some embodiments the processor is also operable to offer the upgrade to one or more of the first set of customers at the price of the bid. In some embodiments the processor is also operable to process acceptance or refusal of the offer for the upgrade by one or more of the first set of customers. In some embodiments the processor is also operable to receive a payment identifier specifying a credit card account for use in providing payment for the upgrade. In some embodiments the good or service may be a cruise reservation, flight reservation, train reservation, car rental reservation, or a hotel reservation. In some embodiments the good or service is a cruise reservation and the upgrade is a stateroom class or category. In some embodiments the processor is also operable to present the first set of customers with an offer to purchase a second good or service. In some embodiments the second good or service is related to the at least one upgrade. In some embodiments the first set of customers is one customer. In some embodiments the first set of customers is a plurality of customers. In some embodiments the second set of customers is one customer. In some embodiments the second set of customers is a plurality of customers. In some embodiments the first set of customers is mutually exclusive of the second set of customers. In some embodiments the first set of customers has one or more customers in common with the second set of customers.

In some embodiments the present invention is an article of manufacture that includes a computer readable medium including instructions that included instructions for: receiving a purchase offer for a good or service from a first set of customers; presenting the first set of customers with at least one upgrade with a plurality of prices for the good or service; receiving a bid from one or more of the first set of customers, wherein the bid is for the at least one upgrade for one of the plurality of prices; deciding whether to accept the bid from one or more of the first set of customers; and presenting an opportunity to purchase a good or service to a second set of customers, wherein the good or service comprises a good or service available as a result of the acceptance of one of the bids from one or more of the first set of customers. In some embodiments the instructions also include instructions for communicating the offer to one or more of the first set of customers. In some embodiments the instructions also include instructions for processing the acceptance or refusal of the offer for the upgrade. In some embodiments the instructions for deciding include instructions for querying a database including bids of a plurality of customers, identifying the bids that selected the highest of the plurality of prices, and determining the availability of the upgrade. In some embodiments the instructions for deciding including instructions for considering at least one non-price criterion. In some embodiments the instructions also include instructions for receiving a payment identifier specifying a credit card account for use in providing payment for the upgrade. In some embodiments the good or service may be a cruise reservation, flight reservation, train reservation, car rental reservation, or a hotel reservation. In some embodiments the good or service is a cruise reservation and the upgrade is a stateroom class or category. In some embodiments the instructions also include instructions for presenting the first set of customers with an offer to purchase a second good or service. In some embodiments the second good or service is related to the at least one upgrade. In some embodiments the first set of customers is one customer. In some embodiments the first set of customers is a plurality of customers. In some embodiments the second set of customers is one customer. In some embodiments the second set of customers is a plurality of customers. In some embodiments the first set of customers is mutually exclusive of the second set of customers. In some embodiments the first set of customers has one or more customers in common with the second set of customers.

### BRIEF DESCRIPTION OF THE DRAWINGS

FIGS. 1a, 1b, and 1c are flowcharts, each showing an embodiment of a method of the present invention.

FIG. 2 is a flowchart showing one aspect of an embodiment of a method of the present invention.

FIG. 3 is a flowchart showing one aspect of an embodiment of a method of the present invention.

FIG. 4 is a flowchart showing one aspect of an embodiment of a method of the present invention.

FIG. 5 is a flowchart showing one aspect of an embodiment of a method of the present invention.

FIG. 6 is a flowchart showing one aspect of an embodiment of a method of the present invention.

FIG. 7 is a schematic block diagram showing an embodiment of a system of the present invention.

FIG. 8 is a schematic block diagram showing an example of a revenue management system of the present invention.

FIGS. 9a and 9b are schematic block diagrams showing an embodiment of an article of manufacture of the present invention.

### DETAILED DESCRIPTION

In the following paragraphs, the present invention will be described in detail by way of example with reference to the associated Figures. Throughout this description, the embodiments and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent.

Thus, it is seen that methods, systems, and articles of manufacture are provided. One skilled in the art will appreciate that the present invention can be practiced by other than the various embodiments which are presented in this description for purposes of illustration and not of limitation, and the present invention is limited only by the claims that follow. It is noted that equivalents for the particular embodiments discussed in this description may practice the invention as well.

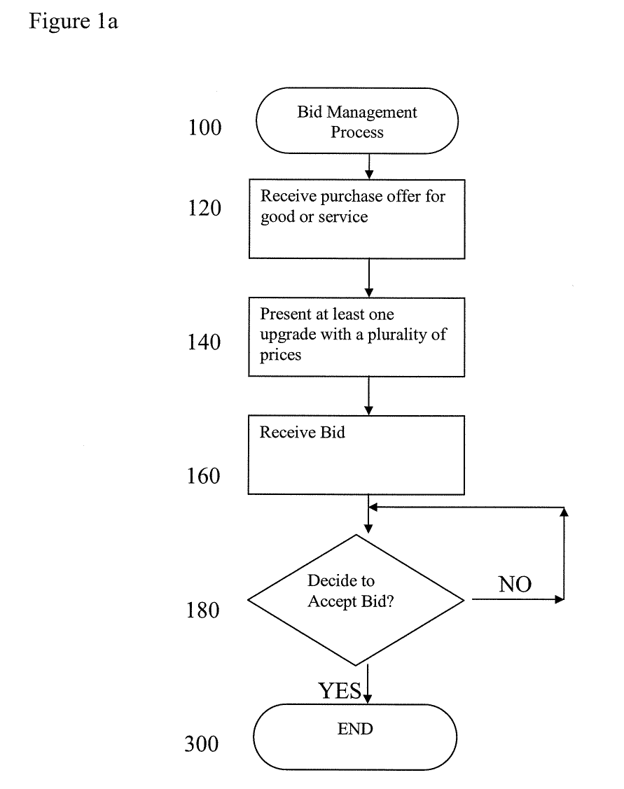

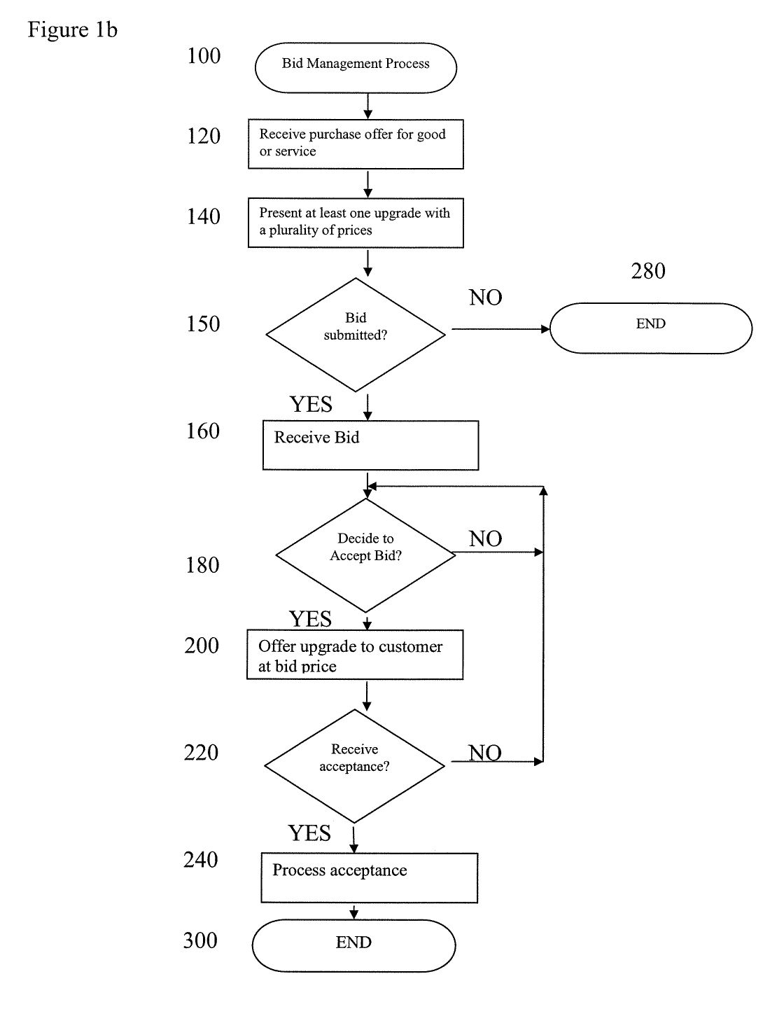

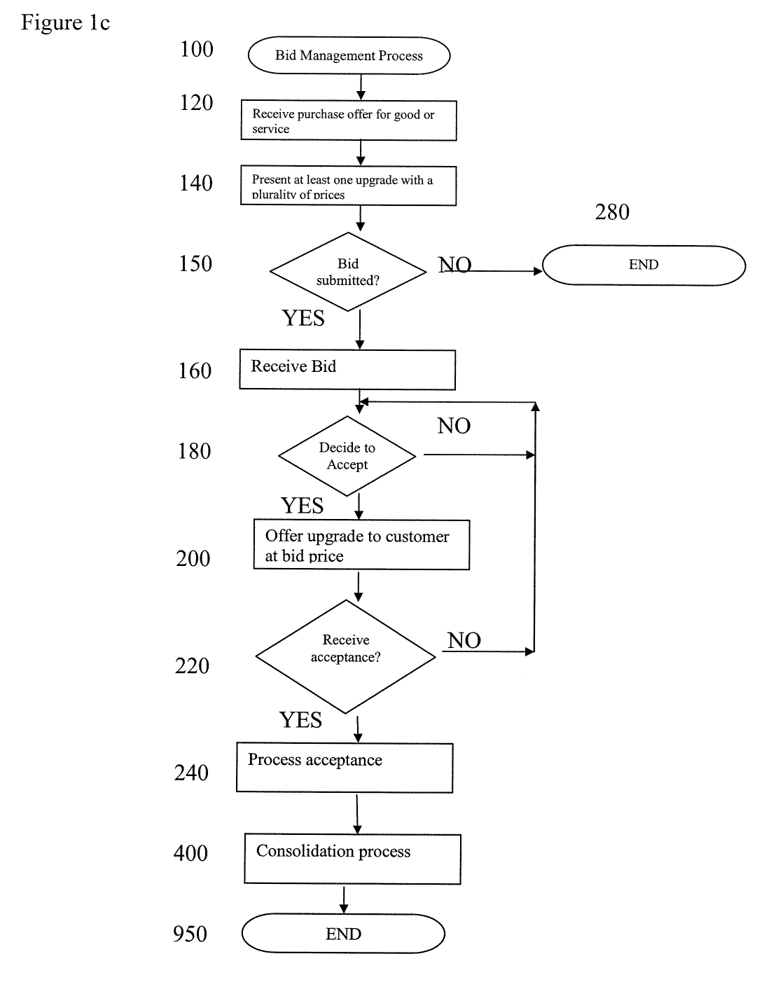

FIG. 1a shows a flowchart describing an embodiment of a method of the present invention. The flowchart shows an embodiment of a bid management process 100 which may be used to present a customer with an opportunity to bid on an upgrade to a good or service that customer has recently offered to buy. This embodiment includes an optional receiving an offer step 120, a presenting an upgrade step 140, a receiving a bid step 160, and a decision step 180. The process can be executed in whole or in part by any computer or microprocessor-based system in any computer language or format and the steps of the various embodiments of the present invention may be performed in any appropriate order. Moreover, the original presentation of the good or service can be performed by any method, whether now known in the art or not. In some embodiments, any given seller may have multiple bid management processes, even for a given good or service. For example, the seller may have a separate system for customers that are frequent purchasers of its goods or services or who have a special status (e.g., a member of a frequent flyer or preferred traveler group, a points holder in a rewards program, a certain level of credit card, and the like). Such separate systems could give priority to one group of customers over another or offer different prices to different groups of customers.

As illustrated in FIG. 1a, one embodiment of the process begins with step 120, where a purchase offer for a good or service is received from a customer. In some embodiments, the step may be automated and may be performed by any suitable software or the like. In other embodiments, the step may be performed by a person or persons. A customer in this context may be an individual, a group of individuals, a travel agent, a travel service, a tour operator, or the like. In some embodiments this offer may be a binding offer to purchase a good or service. As used herein, a good or service may include, but is not limited to, a travel-related good or service, tickets to a sporting event, or tickets to an entertainment event (e.g., movie tickets, play tickets, concert tickets, opera tickets, symphony tickets). In some embodiments, the offer may be for a travel-related good or service. As used herein, a travel-related good or service includes any good or service related to the travel industry. Examples include, but are not limited to, cruise reservations, airline reservations, car rental reservations, hotel reservations, and train reservations or combinations thereof. In one embodiment, the good or service may be a cruise reservation. In some embodiments, this step includes receiving the customer's payment information, e.g., a credit or debit card number or a bank account and routing number. In some embodiments, this step includes retrieving the customer's stored payment information. The purchase offer may be received by any means of communication. For example, the offer may be received via an interactive website, email, in person, telephone, facsimile, mail, or through an intermediary. This step 120 may also comprise the sale or purchase of the good or service by the customer, which in one embodiment occurs before step 140.

After the purchase offer is received, or in an alternative embodiment after the purchase or sale of the good or service is made to the customer, the process either moves to or begins at step 140, presenting the customer with at least one upgrade to the good or service at a price. In some embodiments, the step may be automated and may be performed by any suitable software or the like. In other embodiments, the step may be performed by a person or persons. An upgrade, as used herein, includes an additional good or service relating to the good or service, a higher quality good or service, or the good or service in a higher class or quality. Examples of an additional good or service relating to the good or service, include but are not limited to, a cruise excursion or activity, a tour, a travel-related good or service, tickets to a sporting event, tickets to an entertainment event (e.g., movie tickets, play tickets, concert tickets, opera tickets, symphony tickets), memorabilia, a backstage pass, an opportunity to meet an athlete, a discount or preferred purchasing position for a future event or trip, or additional amenities. Examples of a good or service in a higher class or quality include, but are not limited to, a business class or first class airline ticket, a seat on a given flight on the aisle or window, a higher class of accommodation (including a higher class of stateroom on a cruise), or an improved seating position at a sporting or entertainment event, such as a play, theater or concert, or restaurant. In some embodiments, the offered upgrade may not be a single upgrade, but rather the possibility to get one of a bundle of upgrades. For example, in a cruise embodiment, where the good or service is a stateroom, the upgrade could be a class of stateroom higher than a recited class or a stateroom having an ocean view, or the like. That class of stateroom may be one or more levels higher in class that the one originally purchased or the one that the offer was received for.

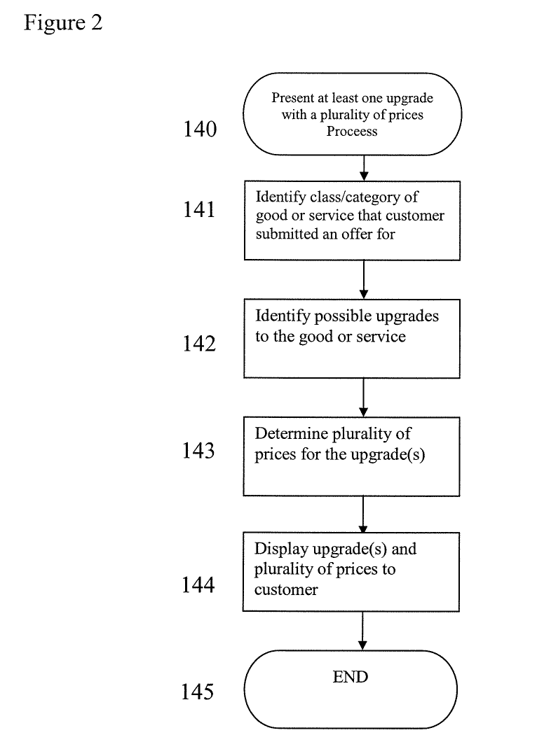

In some embodiments, a single price is presented. In other embodiments, a plurality of prices are presented. Generally, each of the plurality of prices is below the then current market price for the upgrade. In some embodiments, however, the current market price or an even higher price is also presented as one of the plurality of prices. In some embodiments, in addition to the presented price or plurality of prices, the customer is also presented with an option to supply a customer determined price in lieu of selecting a presented price. That price may be at, above, below or between any of the presented plurality of prices. In some embodiments, the customer has the option to immediately purchase the upgrade at a presented price (e.g., the market price), rather than sending in a bid to be evaluated. In some embodiments, estimated odds of success of a particular bid are present next to a particular price. In some embodiments, the prices presented may depend, at least in part, upon one or more characteristic of the buyer, such as the buyer's membership in a frequent buyer or preferred buyer program, special status, the source of the buyer's purchase (e.g., through a travel agent, through the seller's website), or any other characteristic of the buyer or the buyer's purchase offer. For example, a buyer who is a member of a frequent buyer or preferred buyer group for a seller may be presented with a price or plurality of prices that differ from (e.g., one or more of the prices lower than) those presented to a nonmember or those presented to a buyer of a different classification or status (e.g., a “gold” status versus a “platinum” status). Exemplary characteristics of the In one embodiment, the presenting step 140 involves one or more sub-steps. An example of such an embodiment can be seen in FIG. 2.

In FIG. 2, presenting step 140 begins with step 141 where the class or category of the purchased good or service is identified. Next, possible upgrades to that good or service are identified in step 142. Thereafter, one price or a plurality of prices for each possible upgrade are identified or generated in step 143. Importantly, in other embodiments such generation or determination of prices occurs earlier in process 140 or in or before bid management process 100. Such generation of a plurality of prices can be done by any method known in the art or not. A specific method utilizes a reservation management system or some other forecasting process. Various reservation management systems and forecasting processes are known in the art and currently practiced. In step 144 the at least one upgrade and the plurality of prices associated with each upgrade are displayed or presented to the customer. Some embodiments may employ one or more of the sub-steps depicted in FIG. 2.

Such presentation can be done in any manner, form, or format. In one embodiment, the customer may be first presented with the option to see or review the upgrades. For example, a customer may see a message indicating the customer submitted an offer on a good or service of a particular class (e.g., a cruise ship stateroom of a low class), but that at a date closer to the date of the delivery of the good or service (e.g., the date of departure for a cruise ship) the seller may have the good or service available at a higher class (e.g., a cruise ship stateroom of a high class). In such an embodiment, the customer would be asked if he/she is interested in purchasing such an upgrade at a discounted rate. If the customer replied in the affirmative, the customer would then be presented with at least one upgrade having a plurality of prices associated with it. For example, in another embodiment, a customer may be presented an upgrade having a plurality of prices associated with it at a certain time before the event (e.g., a cruise ship stateroom of a certain class at a price or a plurality of prices 2 months before the cruise), but that at a date closer to the date of the delivery of the good or service (e.g., 1 month before the cruise) the customer may also be informed that the good or service is available then at a lower price or plurality of prices. In such an embodiment, the customer would be asked if he/she is interested in purchasing such an upgrade now at a higher price or plurality of prices or later at a lower price or plurality of prices. If the customer replied that it wanted to purchase now rather than later at a potentially lower price, then the customer may maximize its chances of obtaining the upgrade, rther whtan waiting for a lower price, or vice versa. In one embodiment, the display may be performed in a web-based or internet environment. In such an embodiment, each of the plurality of prices may be represented by a visual indicator that is selectable—for example, the visual indicator may be a button, radio button, dropdown, dot, or a check box that the user can select to indicate the selected price. In one embodiment, the customer may be presented with a message indicating that the customer will have the best chance at receiving the upgrade if he/she selects the highest price for any given upgrade.

Such presentation can also be done at any time. In some embodiments, the presentation is done immediately after the purchase offer is received. In other embodiments, the presentation may be done at some time after the purchase offer is received. For example, the presentation may be 1 day, 2 days, 3 days, 4 days, 5 days, 6 days, 8 days, 9 days, 10 days, 11 days, 12 days, 13 days, 1 week, 2 weeks, 3 weeks, 4 weeks, 5 weeks, 6 weeks, 7 weeks, 8 weeks, 1 month, 2 months, 3 months, 4 months, 5 months, 6 months, 7 months, 8 months, 9 months, 10 months, 11 months, or 1 year after the purchase offer is received. In some embodiments, a plurality of presentations occurs, each at a different time. In some such embodiments, the presented prices for the respective upgrade or upgrades may be different each time they are presented. For example, if after a first round of bids the seller determines it would not sufficiently increase its revenue or that an insufficient number of sale were made, the seller may present a second or more time(s) with prices that are higher or lower for each respective upgrade than were initially presented. In some embodiments, the method thus may include offering customers alternate bid prices above the customer's offered bid price if it is deemed that all customer offers are below revenue optimization expectations. In some embodiments, each of the plurality of presentations may include at least one different upgrade. In some embodiments, the additional presentations may provide the customer additional opportunities to submit bids when certain upgrades are no longer available (for example, the upgrade that the customer originally bid on).

Returning now to FIG. 1a, the next step in the depicted embodiment is step 160 receiving the bid from the customer. The receipt of the bid can be done in any manner and at any time. In some embodiments, the step may be automated and may be performed by any suitable software or the like. In other embodiments, the step may be performed by a person or persons. For example, in an embodiment where the plurality of prices for each upgrade may be depicted as a visual indicator that may be selected (e.g., a series of radio buttons), a customer would submit a bid by selecting one such visual indicator (e.g., a radio button) and communicating that selection to the seller. Such communication could be done by clicking a “submit” icon or the like. In such an embodiment, the receipt would be via a web-based program. Of course, the receipt can be performed by a web-based program in various manners, many of which are well-known in the art. In some embodiments, the customer can select one of the plurality of prices for a plurality of different possible upgrades. In such an embodiment, multiple bids could be received from any one customer. In some embodiments, this step includes receiving a customer identifier, such as a booking number or confirmation number. In some embodiments, the customer identifier serves to identify both the customer and information regarding the customer's offer for a good or service or purchase of a good or service. In some embodiments, the information regarding the customer's offer includes the source of the offer (e.g., the seller's website, a travel agent, telephone, facsimile, a consolidator, a travel website, or any other source). The subsequent upgrades and/or goods or services offered may be priced at a price or a plurality of prices according to the information associated with the customer identifier and customer information, or customer status.

Step 160 can occur at any time after step 140. In some embodiments, the bid is received immediately after the presentation of the upgrades to the customer. In other embodiments, the bid may be received at some time after the presentation of the upgrades to the customer. For example, the bid may be received 1 day, 2 days, 3 days, 4 days, 5 days, 6 days, 8 days, 9 days, 10 days, 11 days, 12 days, 13 days, 1 week, 2 weeks, 3 weeks, 4 weeks, 5 weeks, 6 weeks, 7 weeks, 8 weeks, 1 month, 2 months, 3 months, 4 months, 5 months, 6 months, 7 months, 8 months, 9 months, 10 months, 11 months, or 1 year after the presentation of the upgrades. In some embodiments, bids may be received from a customer at a plurality of times.

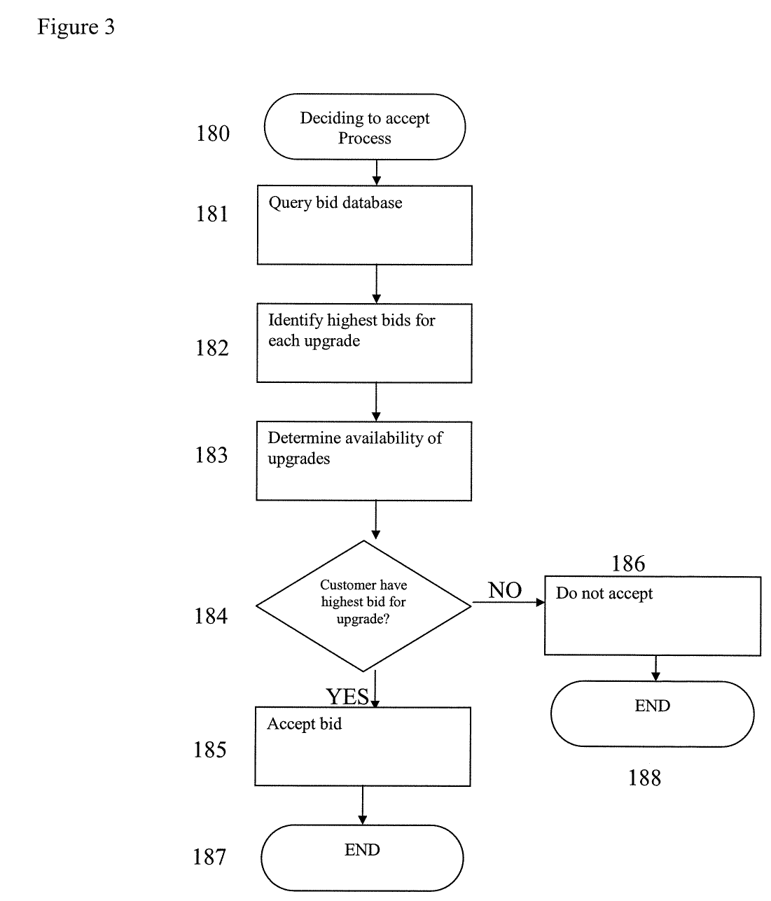

At any time after receiving bid step 160, the process performs step 180 and decides whether to accept any bid(s) submitted by a customer. Such decision can be made in many different ways and at different times. In some embodiments, the decision step 180 occurs at different times for different customers. In some embodiments, the decision step 180 occurs multiple times. In some embodiments, the decision to accept a bid may be based entirely upon the price of the bid and the availability of the upgrade. In other embodiments, the decision to accept a bid may include at least one non-price criterion. Examples of such a non-price criterion include the price paid by the customer for the original good or service, status of the customer as a frequent or preferred traveler (e.g., through a frequent traveler or rewards program such as a frequent flyer card, or as a holder of a particular credit card or the like), whether the customer is an individual or a travel agent or tour company, whether the customer has previously purchased travel from the seller, the source of the seller's purchase offer (e.g., the seller's website, a travel agent, telephone, facsimile, a consolidator, a travel website, or any other source), or the seller's credit rating or a combination thereof. In some embodiments, the decision may be made at a date sometime after the receipt of the purchase offer in step 120. In some embodiments, the step may be performed concurrently to the date of delivery of the good or service or receipt of the bid. In this context, “concurrently” has a broad meaning. For example, the decision could be made 1 day, 2 days, 3 days, 4 days, 5 days, 6 days, 8 days, 9 days, 10 days, 11 days, 12 days, 13 days, 1 week, 2 weeks, 3 weeks, 4 weeks, 5 weeks, 6 weeks, 7 weeks, 8 weeks, 1 month, 2 months, 3 months, or 4 months prior to the date of delivery of the good or service. In some embodiments, the decision can be made multiple times each at a different time period in advance of the date of delivery of the good or service. In some embodiments, the decision may be made by a revenue management system or similar type of system. In some embodiments, if the customer's bid is not accepted, the customer receives a notification that the bid has not been accepted. In such embodiments, the customer may be offered an opportunity to submit a new bid. In some embodiments, the decision is made by reference to external databases or computers. In some embodiments, the decision is made according to a stored rule set, a set of strict conditions, or the like. In some embodiments, the decision includes multiple steps. An example of such an embodiment is shown in FIG. 3.

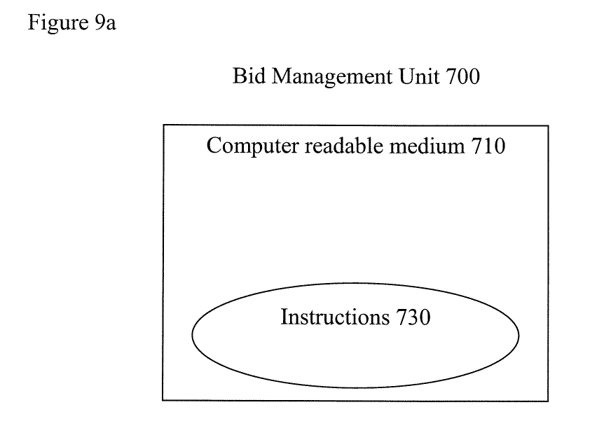

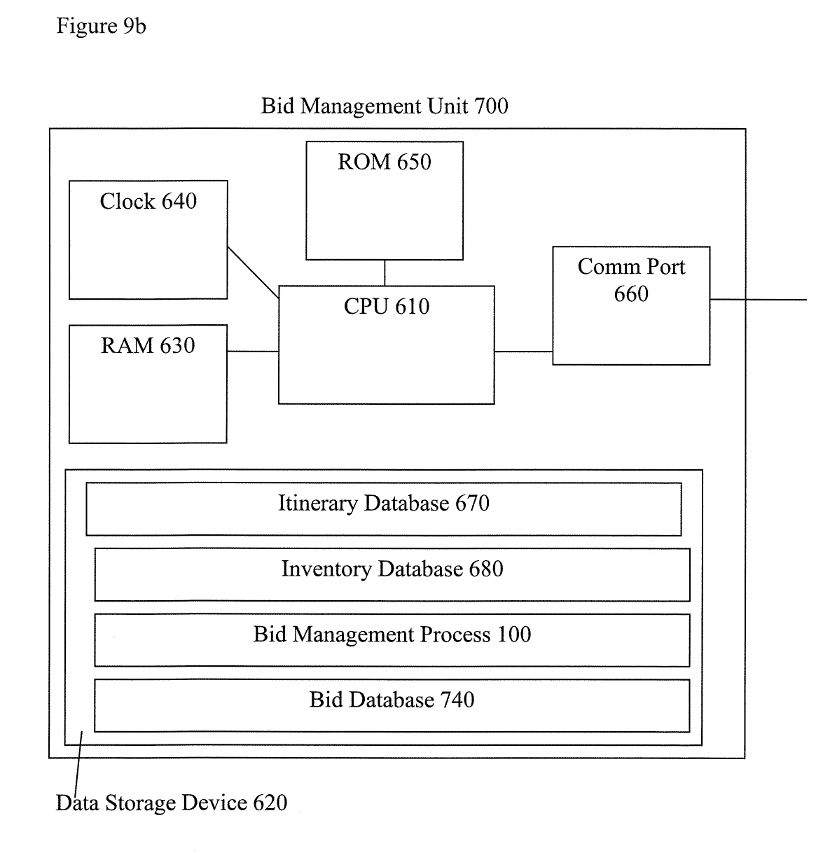

FIG. 3 shows an embodiment that includes several sub-steps to the step of deciding to accept a bid 180. Some embodiments may perform one or more of the sub-steps depicted in FIG. 3. FIG. 3 starts with query bid database step 181. The bid database 740 (see FIG. 9b) can be any appropriate type or form of database. The bid database can store either all bids received by a seller or all bids received by a seller for a particular good or service (e.g., a database for a single cruise berth). The bids can also be stored among several linked databases. In step 182, the bid database is searched and the highest bids for any particular upgrade or for each possible upgrade are identified. In step 183, the availability of one or more upgrades is determined. This can be performed in a variety of ways. In one embodiment, this may be done by accessing a database that has the available inventory for a seller's goods or services or the inventory for any particular good or service of the seller (e.g., a database for a single cruise berth). Such an inventory database can be any type or form of database and can be multiple linked databases. In one embodiment, once the database is accessed it is searched and the available number of all and/or of any particular upgrade(s) is identified. Step 184 is deciding whether the customer has the highest bid or one of the highest bids for an upgrade. If the customer does not have one of the highest bids for an upgrade, the process goes to step 186 and the customer's bid for that upgrade is not accepted. If the customer does have one of the highest bids for any particular upgrade and that particular upgrade is available, the customer's bid is accepted in step 185. If the customer has made bids on a plurality of upgrades and the customer has the highest bids on a plurality of upgrades, all bids or only certain bids may be accepted. In one embodiment, the customer's bid for the highest level of upgrade is the only bid accepted. In another embodiment, the customer's bids for each or more than one upgrade are accepted.

Returning to FIG. 1a, if the decision at step 180 is not to accept a bid, then the step 180 may be repeated (as indicated by the arrows going back prior to step 180). This shows that step 180 may be repeated one or more times for a given customer. This repeat could occur at any time after the first time step 180 is performed and may be voluntary or involuntary by the customer or seller. For example, it could be done the same day as the first run, or 1 day, 2 days, 3 days, 4 days, 5 days, 6 days, 8 days, 9 days, 10 days, 11 days, 12 days, 13 days, 1 week, 2 weeks, 3 weeks, 4 weeks, 5 weeks, 6 weeks, 7 weeks, 8 weeks, 1 month, 2 months, 3 months, or 4 months after the first run. Repeating step 180 could be done for any of a variety of reasons. In one embodiment, the step 180 may be performed after any change in the inventory database. In another embodiment, the step 180 can be performed after any customer has declined to execute an accepted bid. In yet another embodiment, the step 180 may be performed at set time intervals or various time intervals as the date of delivery of the good or service approaches.

Turning now to FIG. 1b, a flowchart is depicted showing another embodiment of a process or method of the present invention. FIG. 1b includes all of the steps of FIG. 1a, but also shows additional steps 150, 200, 220, and 240. All steps FIG. 1b shares with FIG. 1a can be performed in the manner described with respect to FIG. 1a and/or related FIGS. 2 and 3.

Step 150 is a decision step which determines if a bid has been submitted by the customer. Such a decision can be made by any suitable means. In some embodiments, the step may be automated and may be performed by any suitable software or the like. In other embodiments, the step may be performed by a person or persons. In some embodiments, if a customer does not submit a bid, the process ends. In other embodiments, if the customer does not submit a bid, the customer may be contacted at other times and presented with additional opportunities to submit a bid on the same upgrades or different upgrades. In some such embodiments, the customer is presented with the option of whether to receive such additional opportunities to submit a bid. If the customer does submit a bid, the process moves to step 160, receiving the bid. Step 200 is offering the upgrade to the customer. The offer of the upgrade is made at the price of the customer's bid. In some embodiments, an offer may be at a price lower than the customer's bid, if, for example, the customer has already declined to accept an offer at the bid price. As discussed with respect to step 180 (and its possible associated sub-steps) the offer may be for a single bid or for a plurality of bids. The offer may be made to the customer by any suitable method. For example, the offer may be sent via electronic mail, page, text message, facsimile, telephone call, regular mail or any other suitable means or by any combination of the foregoing. In some embodiments the offer may be sent by multiple means. In some embodiments, a follow up to the offer may be sent after the offer is first sent. In such an embodiment, the follow up contact may be by a method that is the same or is different than that used to communicate the offer. For example, the offer may be sent by email and the follow up contact may be by telephone. In one embodiment, the offer may be made by sending an electronic mail to the customer. In some embodiments, the electronic mail includes instructions on how to accept the offer, the terms of the offer, and/or an electronic link to a web site on which the customer can submit its acceptance. There also may be time limits on accepting the offer. For example, the customer may be required to accept the offer within 1 day, 2 days, 3 days, 4 days, 5 days, 6 days, 8 days, 9 days, 10 days, 11 days, 12 days, 13 days, 1 week, 2 weeks, 3 weeks, 4 weeks, 5 weeks, 6 weeks, 7 weeks, 8 weeks, 1 month, 2 months, 3 months, or 4 months of receipt.

Step 220 is a decision step that determines whether the customer's acceptance has been received. This step may take a variety of forms. In one embodiment, the customer's acceptance may be automatic (i.e., the customer's bid may be a binding one). In another embodiment, the customer's acceptance may be deemed received if the customer does not contact the seller to indicate the customer would like to withdraw his/her bid. In yet another embodiment, the customer's acceptance may be deemed received only if the customer affirmatively acts to accept the offer. The receipt of the acceptance can be by, for example, telephone, regular mail, electronic mail, text message, facsimile, or through a web site. In some embodiments, the step may be automated and may be performed by any suitable software or the like. In other embodiments, the step may be performed by a person or persons who receive and process the acceptance. If acceptance of an offer is not received (whether by omission or an affirmative act by the customer declining to accept the offer), the process may return to step 180, as indicated by the arrows from step 220 back to step 180. This return to step 180 from step 220 may be under the circumstances or for any of the reasons discussed with respect to the return to step 180 in FIG. 1a. If the acceptance is received, the process moves on to step 240, the processing of the acceptance.

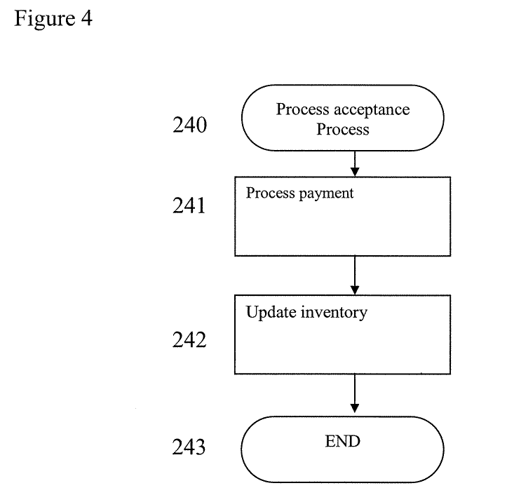

Step 240 may be executed in any suitable manner. For example, step 240 may be performed by a person or persons who receive and process the acceptance. In some embodiments, the step may be at least partially automated and may be performed by any suitable software or the like. In some embodiments, step 240 involves one or more of the sub-steps shown in the flowchart of FIG. 4. FIG. 4 shows step 241 process payment. This step may take a variety of forms. In some embodiments, this step includes receiving the customer's payment information, e.g., a credit or debit card number or a bank account and routing number. In some embodiments, this step includes retrieving stored payment information for a customer. In some embodiments, receiving the customer's payment information includes receiving the customer's frequent traveler (e.g., frequent flyer number, preferred or elite traveler status or the like) number or information, or a promotional code or an indication that the customer will utilize a gift certificate, travel “points” or the like to pay for part or all of the good or service or upgrade. In some embodiments, the step includes receiving information from the customer regarding stored credits (e.g., points) the customer may have with the seller and using those credits to pay for part or all of the good or service or upgrade. In other embodiments, the step involves re-using the payment information submitted by the customer in his/her purchase of the good or service. In other embodiments, the step involves accessing payment information a customer has saved on the seller's web site. In some embodiments, this step also involves obtaining all required clearances or performing all tasks required to ensure payment is fully accepted. For example, if payment is by credit card, step 241 may include receiving approval for the charge from the customer's credit card operator.

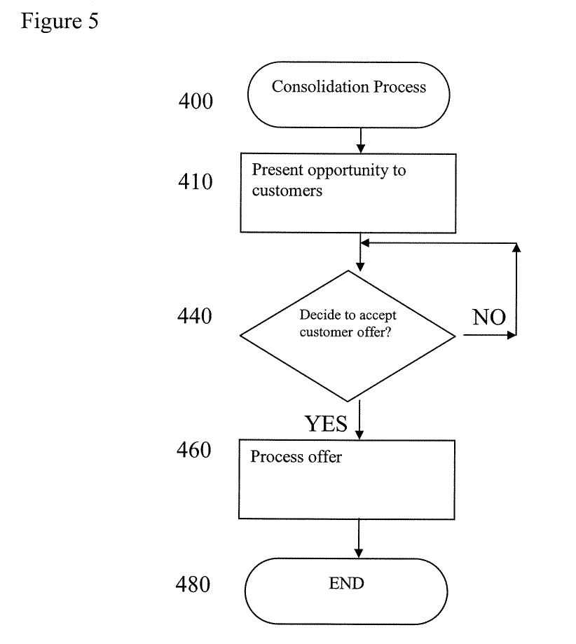

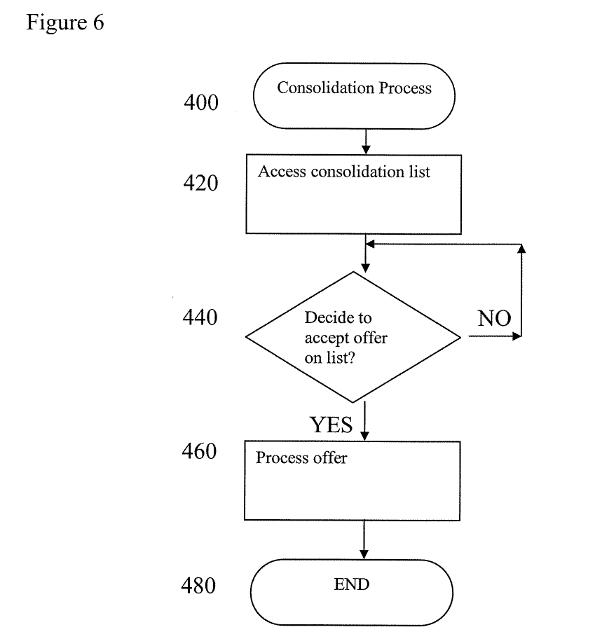

Step 242 is updating the inventory. In some embodiments, step 242 may be performed by a person or persons. In some embodiments, step 242 may be at least partially automated and may be performed by any suitable software or the like. In some embodiments, this step involves accessing an inventory database and updating it to indicate that the upgrade has been purchased and that the good or service that had been purchased by the upgrading customer is now available. In some embodiments, the updating of the inventory step 242 results in a repeat of one or more of steps 140 and 180 (and any additional necessary steps). In some embodiments, for example the embodiment depicted in FIG. 1c, the updating of the inventory triggers a consolidation process or system—an embodiment of such a process is depicted in FIGS. 5 and 6.

FIG. 5 shows an exemplary embodiment of consolidation process 400. In some embodiments, consolidation process 400 offers for sale a good or service that becomes available as the result of a customer's acceptance of an offer for an upgrade. For example, in a cruise embodiment, a customer may accept an offer of an upgrade that is a higher level of stateroom, which results in a lower level stateroom being available for purchase. In some embodiments the opportunity may be presented to a set (i.e., one or more) of customers that were not offered an upgrade or that did not or have not purchased a good or service. In some embodiments, consolidation process is prospective and may serve to collect customer offers, bids, and/or acceptances of offers before a good or service becomes available for consolidation. In some such embodiments a consolidation list is formed, which contains such prospective offers, bids, and/or acceptances. In some embodiments, the consolidation list is stored as or in a database.

Step 410 is presenting an opportunity to purchase a consolidation good or service to a customer or customers. Step 410 may occur at any time, including before or after a good or service becomes available for consolidation. In some embodiments, the offer may be presented at a price that is lower than the market or list price for the good or service. In some embodiments, a plurality of prices are presented for a given good or service. In some such embodiments, the consolidation process will be substantially similar to bid process 100, but instead of an upgrade, the subject of the bids will be the good or service subject to consolidation. The opportunity may be presented in any manner or form. For example, the opportunity may be presented on a web-site related to the seller or the seller's industry, on the seller's website, via telephone, via facsimile, via email, via mail, via an intermediary, or any other suitable means. In some embodiments, the seller may have a “consolidation” or “last minute offers” link on its web-site on which the opportunity. In some embodiments, the opportunity may be presented via a pop-up window, email, or the like, to persons who access the seller's website or those who agree to be contacted by the seller or those that the seller has contact information for. In some embodiments, customer information (e.g., pages accessed on the seller's website and past purchases) may be used to select which opportunities may be presented to the customer. The customer's bid or offer of acceptance may be communicated to the seller and received by the seller via any suitable method or means (e.g., those discussed with respect to step 160 of bid management process 100).

Step 440 is a decision step whereby the seller determines whether or not accept an offer. This step may be substantially similar to step 180 of bid management process 100 and may occur at any time, including concurrently with the time of delivery.

Step 460 is the processing of the customer's bid or offer. This step is substantially similar to steps 200, 220, and 240 of bid management process 100.

FIG. 6 shows an alternative embodiment of consolidation process 400. In this embodiment, step 420 access consolidation list is performed. Step 420 accesses a list of customer offers previously received for a given good or service. The offers present in the consolidation list may be procured, received, and stored in any suitable manner.

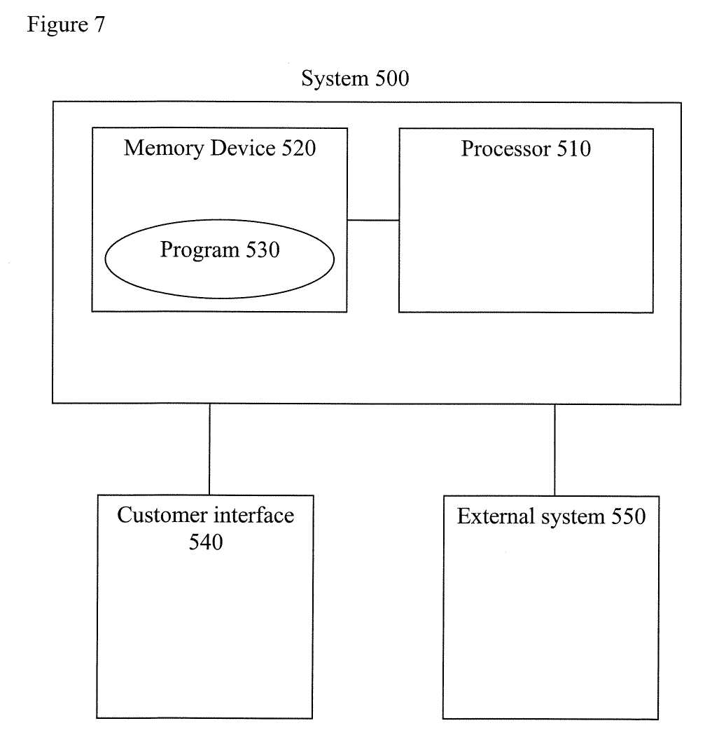

FIG. 7 is a basic schematic block diagram showing an embodiment of a system of the present invention. System 500 has elements central processing unit (CPU) 510, memory device 520, and program 530. System 500 may be embodied in a single unit or multiple units functionally connected by any suitable means. Examples of single unit system 500 include a server, a microcomputer or the like. CPU 510 can be anything operable to retrieve, interpret, and/or execute program 530. In some embodiments, CPU 510 may be one or more microprocessors. For example, processor 510 could be any one of Intel Corporation's processors (e.g. Xeon®, Centrino®, Celeron®, or Pentium®, Advanced Micro Design, Inc.'s processors (e.g. Athlon™ or Sempron™), Sun Microsystem Inc.'s processors, or Motorola Inc.'s processors. Memory device 520 can be any computer readable medium. For example, memory device 520 could be a floppy disk, flash drive, external hard drive, hard drive, ROM chip, cd ROM, or the like. Program 530 includes computer readable instructions to carry out any embodiment of a process or method of the present invention, including those discussed with reference to FIGS. 1a, 1b, 2, 3, 4, 5 and 6 and all variations of those processes or methods. The computer readable instructions can be in any programming language.

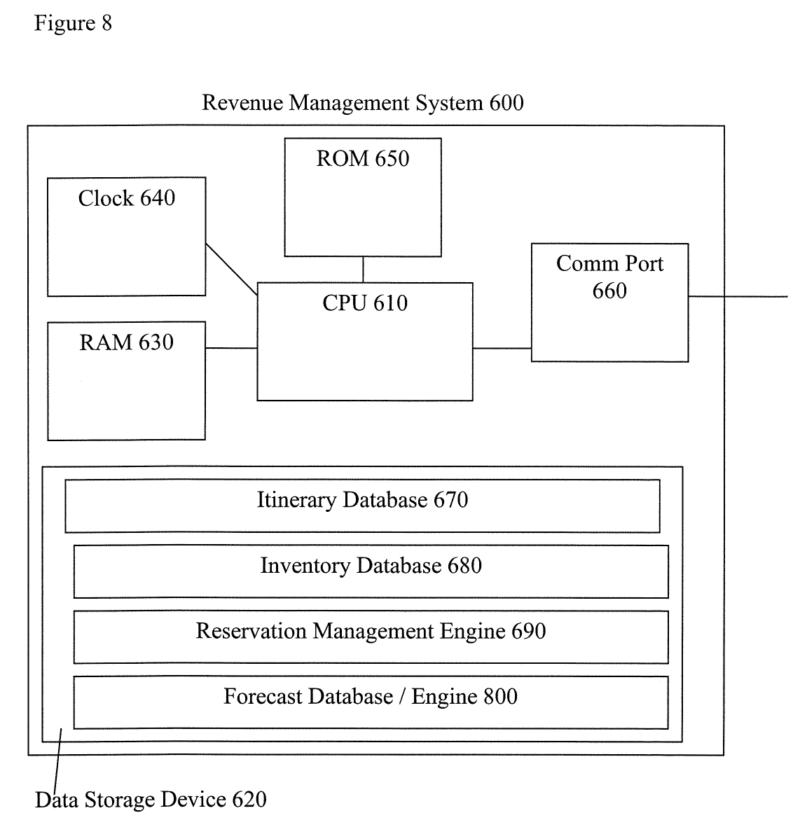

FIG. 7 also shows optional elements customer interface 540 and external system 550. Customer interface 540 can be unitary with one or both of memory device 520 and/or processor 510. Customer interface 540 can also be separate from processor 510 and memory device 520 and functionally connected to them. Customer interface can take any form which permits a customer to interact with program 530. In one embodiment, customer interface 540 may be a personal microcomputer such as an Apple Macintosh™ or a microcomputer with an Intel-based processor. In such an embodiment, system 500 may be functionally connected to customer interface 540 by way of the Internet. External system 550 can be a system, memory, processor or the like that may be functionally connected to system 500. In some embodiments, external system 550 aids system 500 in executing program 530 by storing related databases, information, programs, processes or the like. In one embodiment, external system 550 may comprise one or more of revenue management system 600 and bid management system 700, as depicted by way of example in FIG. 8, 9a and 9b. FIG. 8 shows an example of a revenue management system 600.

FIG. 8 is a block diagram showing an architecture for an exemplary revenue management system 600. Revenue management system 600 can take various forms both known in the art and not. Such systems are well known in the art and their design is within the scope of the skilled artisan. Generally, revenue management system 600 may be utilized to optimize revenue per good or service (e.g., per flight or cruise berth). For example, revenue management engine 690 can perform seat or cabin inventory control by periodically adjusting nested booking limits (or buckets) for the various fare classes, in order to optimize the passenger mix and thereby maximize the generated revenue per good or service.

The exemplary system may include standard hardware: CPU 610, clock 640, RAM 630, ROM 650, communication port 660, and data storage device 620. CPU 610 may be one or more commercially available processors such as any one of Intel Corporation's processors (e.g. Xeon®, Centrino®, Celeron®, or Pentium®), Advanced Micro Design, Inc.'s processors (e.g. Athlon™ or Sempron™), Sun Microsystem Inc.'s processors, or Motorola Inc.'s processors, and may be functionally connected to the other hardware components, for example by way of a shared data bus or dedicated connections. ROM 650 and data storage device 620 are operable to store one or more instructions or sets of instructions. In some embodiments the instructions include receiving and processing a customer's payment information, including the ability to communicate with a credit card issuer to ensure payment. Communications port 660 can be any form of communications port able to connect one computer system to one or more other computer systems. Communication port 660 functions to connect the revenue management system 600 to any external system. For example, it may connect revenue management system 600 to system 500 depicted in FIG. 7.

In some embodiments, the data storage device 620 includes one or more databases and programs/engines. For example, FIG. 8 shows an itinerary database 670, an inventory database 680, and a forecast database/engine 800. These databases may be in any form or format. Itinerary database 670 may store, for example the dates, times, locations, destinations, departure points, and/or equipment available for any given seller or group of sellers. For example, if the seller were a cruise operator, itinerary database 670 may contain information such as the cruise dates and destinations and the cruise ship allocated to each particular date and destination. Inventory database 680 may store, for example, the reservations received/purchased for the relevant goods or services. For example, if the seller were a cruise operator, the inventory database 680 may store the class and fares of staterooms that have been booked and that are available to be booked for any given cruise berth. Forecast database/engine 800 can be a set of instructions for forecasting demand of the relevant goods and services. For example, if the seller was a cruise operator, forecast database/engine 800 could be a set of instructions that forecasts demand for various classes of staterooms for a given cruise berth. In some embodiments, the forecast database/engine 800 may be a database storing various forecasts for demand of the relevant goods or services under various conditions. Revenue management engine 690 can take various forms both known in the art and not. Such engines are well known in the art and their design is within the scope of the skilled artisan. Generally, the revenue management engine 690 may be utilized to optimize revenue per good or service (e.g., per flight or cruise berth), in a known manner. For example, revenue management engine 690 can perform seat or cabin inventory control by periodically adjusting nested booking limits (or buckets) for the various fare classes, in order to optimize the passenger mix and thereby maximize the generated revenue per good or service.

FIG. 9a shows a basic embodiment of an article of manufacture of the present invention. Computer readable medium 710 can be any such medium known in the art or not. For example, computer readable medium 710 could be a floppy disk, flash drive, external hard drive, hard drive, ROM chip, cd ROM, or the like. Instructions 730 are stored on computer readable medium 710. Instructions 730 enable a computer or like-machine or system, to perform an embodiment of a method or process of the present invention, including those discussed with reference to FIGS. 1a, 1b, 2, 3, 4, 5 and 6 and all variations of those processes or methods. Instructions 730 can be in any form, language, or format. Preferably, instructions 730 are in a form directly readable and executable by a computer or computer system.

FIG. 9b shows a more detailed embodiment of an article of manufacture of the present invention. Like the revenue management system 600 depicted in FIG. 8, bid management unit 700 generally may have certain hardware items: CPU 610, clock 640, RAM 630, ROM 650, communications port 660, and data storage device 620. These pieces of hardware are as described with respect to FIG. 8. As depicted in FIG. 9b, data storage device 620 contains bid database 740, bid management process 100, inventory database 680, and itinerary database 670. However, in some embodiments data storage device 620 only contains bid management process 100. In other embodiments the data storage device 620 may contain bid management process 100 and one or more of consolidation process 400, bid database 740, inventory database 680, itinerary database 670, reservation management engine 690, or forecast database/engine 800. Bid management process 100 can be any embodiment of the methods or processes of the present invention. For example, bid management process may be the processes exemplified in FIGS. 1a, 1b, 2, 3, and 4, and all variations thereto. Bid database 740 can be in any form and format and generally contains all bids received from customers.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

I claim:

1. A method comprising the steps of:
receiving a purchase offer for a good or service from a customer;
presenting said customer with at least one upgrade with a plurality of prices for said good or service;
receiving a bid from said customer, wherein said bid is for said at least one upgrade for one of said plurality of prices; and
deciding whether to accept said bid from said customer.

2. The method of claim 1 wherein said deciding step comprises:
querying a database comprising bids of a plurality of customers;
identifying said bids for each upgrade that selected the highest of said plurality of prices; and
determining the availability of each said upgrade.

3. The method of claim 2 wherein said database is stored in a computer reservation system.

4. The method of claim 1 further comprising offering said upgrade to said customer at the price of said bid.

5. The method of claim 4 further comprising processing said customer's acceptance or refusal of the offer for said upgrade.

6. The method of claim 1 wherein said deciding step takes place at a time concurrently to the date of delivery of said good or service.

7. The method of claim 1 wherein said deciding step includes consideration of at least one non-price criterion.

8. The method of claim 1 further comprising receiving a payment identifier specifying a credit card account for use in providing payment for said upgrade.

9. The method of claim 1 wherein said good or service is selected from the one or more of the group consisting of a cruise reservation, flight reservation, train reservation, car rental reservation, and a hotel reservation.

10. The method of claim 9 wherein said good or service is a cruise reservation and said upgrade is a stateroom class or category.

11. The method of claim 1 further comprising the step of presenting said customer with an offer to purchase a second good or service.

12. The method of claim 11 wherein said second good or service is related to said at least one upgrade.

13. A system comprising:
a memory device storing a program;
a processor in communication with said memory device;
said processor operable with said program to:
receive a purchase offer for a good or service from a customer;
present said customer with at least one upgrade with a plurality of prices for said good or service;
receive a bid from said customer, wherein said bid is for said at least one upgrade for one of said plurality of prices; and
decide whether to accept said bid from said customer.

14. The system of claim 13 wherein said processor is further operable to:
query a database comprising bids of a plurality of customers;
identify said bids for each upgrade that selected the highest of said plurality of prices; and
determine the availability of each said upgrade.

15. The system of claim 13 wherein said processor is further operable to offer said upgrade to said customer at the price of said bid.

16. The system of claim 13 wherein said processor is further operable to process said customer's acceptance or refusal of the offer for said upgrade.

17. The system of claim 13 wherein said processor is further operable to receive a payment identifier specifying a credit card account for use in providing payment for said upgrade.

18. The system of claim 13 wherein said good or service is selected from the one or more of the group consisting of a cruise reservation, flight reservation, train reservation, car rental reservation, and a hotel reservation.

19. The system of claim 18 wherein said good and/or service is a cruise reservation and said upgrade is a stateroom class or category.

20. The system of claim 18 wherein said processor is further operable to present said customer with an offer to purchase a second good or service.

21. The system of claim 20 wherein said second good or service is related to said at least one upgrade.

22. An article of manufacture comprising:
a computer readable medium comprising instructions, said instructions comprising instructions for:
receiving a purchase offer for a good or service from a customer;
presenting said customer with at least one upgrade with a plurality of prices for said good or service;
receiving a bid from said customer, wherein said bid is for said at least one upgrade for one of said plurality of prices; and
deciding whether to accept said bid from said customer.

23. The article of manufacture of claim 22 wherein said instructions further comprise instructions for communicating said offer to said customer.

24. The article of manufacture of claim 22 wherein said instructions further comprise instructions for processing the acceptance or refusal of the offer for said upgrade.

25. The article of manufacture of claim 22 wherein said instructions for deciding comprise instructions for querying a database comprising bids of a plurality of customers, identifying said bids that selected the highest of said plurality of prices, and determining the availability of said upgrade.

26. The article of manufacture of claim 22 wherein said instructions for deciding comprise instructions for considering at least one non-price criterion.

27. The article of manufacture of claim 22 wherein said instructions further comprise instructions for receiving a payment identifier specifying a credit card account for use in providing payment for said upgrade.

28. The article of manufacture of claim 22 wherein said good or service is selected from the one or more of the group consisting of a cruise reservation, flight reservation, train reservation, car rental reservation, and a hotel reservation.

29. The article of manufacture of claim 28 where said good or service is a cruise reservation and said upgrade is stateroom classes or categories.

30. The article of manufacture of claim 22 wherein said instructions further comprise instructions for presenting said customer with an offer to purchase a second good or service.

31. The article of manufacture of claim 30 wherein said second good or service is related to said at least one upgrade.

32. A system comprising:
a memory device storing a program;
a processor in communication with said memory device;
said processor operable with said program to:
receive a purchase offer for a good or service from a plurality of customers;
present each of said plurality of customers with at least one upgrade with a plurality of prices for said good or service;
receive a bid from each of said plurality of customers, wherein said bid is for said at least one upgrade for one of said plurality of prices; and
decide whether to accept said bid from said customer.

33. The system of claim 32 wherein said processor is further operable to:
query a database comprising the bids of said plurality of customers;
identify said bids for each upgrade that selected the highest of said plurality of prices; and
determine the availability of each said upgrade.

34. The system of claim 32 wherein said processor is further operable to offer said upgrade to each of said plurality of customers at the price of said bid.

35. The system of claim 32 wherein said processor is further operable to process the acceptance or refusal of the offer for said upgrade by each of said plurality of customers.

36. The system of claim 32 wherein said processor is further operable to receive a payment identifier specifying a credit card account for use in providing payment for said upgrade.

37. The system of claim 32 wherein said good or service is selected from the one or more of the group consisting of a cruise reservation, flight reservation, train reservation, car rental reservation, and a hotel reservation.

38. The system of claim 32 wherein said good or service is a cruise reservation and said upgrade is a stateroom class or category.

39. The system of claim 35 wherein said processor is further operable to again decide whether to offer one or more of said upgrade to each of said plurality of consumers.

40. The system of claim 39 wherein said processor is further operable to:
query a database comprising the bids of said plurality of customers;
identify said bids for each upgrade that selected the highest of said plurality of prices; and
determine the availability of each said upgrade.

41. An article of manufacture comprising:
a computer readable medium comprising instructions, said instructions comprising instructions for:
receiving a purchase offer for a good or service from a customer;
presenting each of said plurality of customers with at least one upgrade with a plurality of prices for said good or service;
receiving a bid from at least one of said plurality of customers, wherein said bid is for said at least one upgrade for one of said plurality of prices; and
deciding whether to accept said bid from said customer.

42. The article of manufacture of claim 41 wherein said instructions further comprise instructions for communicating said offer to at least one of said plurality of customers.

43. The article of manufacture of claim 41 wherein said instructions further comprise instructions for processing the acceptance or refusal of the offer for said upgrade.

44. The article of manufacture of claim 41 wherein said instructions for deciding comprise instructions for querying a database comprising bids from said plurality of customers, identifying said bids that selected the highest of said plurality of prices, and determining the availability of said upgrade.

45. The article of manufacture of claim 22 wherein said instructions for deciding comprise instructions for considering at least one non-price criterion.

46. The article of manufacture of claim 41 wherein said instructions further comprise instructions for receiving a payment identifier specifying a credit card account for use in providing payment for said upgrade.

47. The article of manufacture of claim 41 wherein said good or service is selected from the one or more of the group consisting of a cruise reservation, flight reservation, train reservation, car rental reservation, and a hotel reservation.

48. The article of manufacture of claim 47 wherein said good or service is a cruise reservation, and said upgrade is a stateroom class or category.

49. The article of manufacture of claim 43 wherein said instructions further comprise again deciding whether to offer one or more of said upgrade to each of said plurality of consumers.

50. The article of manufacture of claim 49 wherein said instructions for deciding comprise instructions for querying a database comprising bids from said plurality of customers, identifying said bids that selected the highest of said plurality of prices, and determining the availability of said upgrade.

51. A method comprising the steps of:
receiving a purchase offer for a good or service from a first set of customers presenting said first set of customers with at least one upgrade with a plurality of prices for said good or service;
receiving a bid from one or more of said first set of customers, wherein said bid is for said at least one upgrade for one of said plurality of prices;
deciding whether to accept said bid from one or more of said first set of customers; and
presenting an opportunity to purchase a good or service to a second set of customers, wherein said good or service comprises a good or service available as a result of the acceptance of one of said bids from one or more of said first set of customers.

52. The method of claim 51 wherein said deciding step comprises:
querying a database comprising bids of a plurality of said first set of customers;
identifying said bids for each upgrade that selected the highest of said plurality of prices; and
determining the availability of each said upgrade.

53. The method of claim 52 wherein said database is stored in a computer reservation system.

54. The method of claim 51 further comprising offering said upgrade to one or more of said first set of customers at the price of said bid.

55. The method of claim 54 further comprising processing acceptance or refusal of the offer for said upgrade by one or more of said first set of customers.

56. The method of claim 51 wherein said deciding step takes place at a time concurrently to the date of delivery of said good or service.

57. The method of claim 51 wherein said deciding step includes consideration of at least one non-price criterion.

58. The method of claim 51 further comprising receiving a payment identifier specifying a credit card account for use in providing payment for said upgrade.

59. The method of claim 51 wherein said good or service is selected from the one or more of the group consisting of a cruise reservation, flight reservation, train reservation, car rental reservation, and a hotel reservation.

60. The method of claim 51 wherein said good or service is a cruise reservation and said upgrade is a stateroom class or category.

61. The method of claim 51 further comprising the step of presenting said first set of customers with an offer to purchase a second good or service.

62. The method of claim 61 wherein said second good or service is related to said at least one upgrade.

63. A system comprising:
a memory device storing a program;
a processor in communication with said memory device;
said processor operable with said program to:
receive a purchase offer for a good or service from a customer;
present said customer with at least one upgrade with a plurality of prices for said good or service;
receive a bid from said customer, wherein said bid is for said at least one upgrade for one of said plurality of prices; and
decide whether to accept said bid from said customer.

64. The system of claim 63 wherein said processor is further operable to:
query a database comprising bids of a plurality of customers;
identify said bids for each upgrade that selected the highest of said plurality of prices; and
determine the availability of each said upgrade.

65. The system of claim 63 wherein said processor is further operable to offer said upgrade to one or more of said first set of customers at the price of said bid.

66. The system of claim 63 wherein said processor is further operable to process acceptance or refusal of the offer for said upgrade by one or more of said first set of customers.

67. The system of claim 63 wherein said processor is further operable to receive a payment identifier specifying a credit card account for use in providing payment for said upgrade.

68. The system of claim 63 wherein said good or service is selected from the group consisting of a cruise reservation, flight reservation, train reservation, car rental reservation, and a hotel reservation.

69. The system of claim 68 wherein said good or service is a cruise reservation and said upgrade is a stateroom class or category.

70. The system of claim 63 wherein said processor is further operable to present said first set of customers with an offer to purchase a second good or service.

71. The system of claim 70 wherein said second good or service is related to said at least one upgrade.

72. An article of manufacture comprising:
a computer readable medium comprising instructions, said instructions comprising instructions for:
receiving a purchase offer for a good or service from a first set of customers
presenting said first set of customers with at least one upgrade with a plurality of prices for said good or service;
receiving a bid from one or more of said first set of customers, wherein said bid is for said at least one upgrade for one of said plurality of prices;
deciding whether to accept said bid from one or more of said first set of customers; and
presenting an opportunity to purchase a good or service to a second set of customers, wherein said good or service comprises a good or service available as a result of the acceptance of one of said bids from one or more of said first set of customers.

73. The article of manufacture of claim 72 wherein said instructions further comprise instructions for communicating said offer to one or more of said first set of customers.

74. The article of manufacture of claim 72 wherein said instructions further comprise instructions for processing the acceptance or refusal of the offer for said upgrade.

75. The article of manufacture of claim 72 wherein said instructions for deciding comprise instructions for querying a database comprising bids of a plurality of customers, identifying said bids that selected the highest of said plurality of prices, and determining the availability of said upgrade.

76. The article of manufacture of claim 72 wherein said instructions for deciding comprise instructions for considering at least one non-price criterion.

77. The article of manufacture of claim 72 wherein said instructions further comprise instructions for receiving a payment identifier specifying a credit card account for use in providing payment for said upgrade.

78. The article of manufacture of claim 72 wherein said good or service is selected from the group consisting of a cruise reservation, flight reservation, train reservation, car rental reservation, and a hotel reservation.

79. The article of manufacture of claim 78 wherein said good or service is a cruise reservation and said upgrade is a stateroom class or category.

80. The article of manufacture of claim 72 wherein said instructions further comprise instructions for presenting said first set of customers with an offer to purchase a second good or service.

81. The article of manufacture of claim 80 wherein said second good or service is related to said at least one upgrade.
